(19) United States
(12) Patent Application Publication
(10) Pub. No.: US 2024/0401389 A1
(43) Pub. Date: Dec. 5, 2024

(54) Hinge Assembly

(71) Applicants: MUSIC EXPRESS LLC, Kingston, WA (US); CEDAR CREEK TRUST, Pumpenbil, New South Wales (AU)

(72) Inventors: Timothy Boland, Pumpenbil, New South Wales (AU); Thomas Boland, Pumpenbil, New South Wales (AU)

(21) Appl. No.: 18/694,502

(22) PCT Filed: Oct. 3, 2022
(86) PCT No.: PCT/US2022/045500

§ 371 Date: Mar. 22, 2024

(30) Foreign Application Priority Data
Oct. 1, 2021 (AU) 2021903159

(51) Int. Cl. E05D 11/08; E05D 3/02; G10G 7/00

(52) U.S. Cl. CPC E05D 11/082; E05D 3/02; G10G 7/005

(57) ABSTRACT

A hinge assembly prevents an open lid from inadvertently falling closed, and comprises hinge leaves for attachment to a lid and a container body. A friction torque pair extends along a longitudinal axis and includes a first c-section member resiliently biased toward a smaller diameter axially capturing a second c-section member resiliently biased toward a larger diameter, the c-section members connecting the hinge leaves. The c-section members are configured of substantially rigid resilient material so as to provide friction torque such that when the longitudinal axis is horizontally oriented with the body below the lid, the lid's movement in a closing direction requires greater force than created by the lid's weight to cause relative axial rotation of the c-section members. The hinge assembly has utility with musical instrument cases and containers having a lid.

### TECHNICAL FIELD

The present disclosure relates generally to hinge assemblies for use with cases and boxes or the like, to prevent the lid from inadvertently falling closed or otherwise inadvertently moving towards the closed position.

### BACKGROUND

Historically guitar case hinges and toy box hinges and the like are simple pressed metal butt-hinges that allow the case lid to fall closed. Various forms of hinges exist that do not fall closed if the lid is accidentally dropped during opening, or if bumped when upright in the open position. Such hinges are commonly used for computer notebook screens to hold the screen at any desired viewing angle and to prevent the screen from falling closed. US 2006/0272129 A1 teaches a friction hinge comprising two cylindrical members filled with a viscous damping fluid and a third cylindrical member which co-act to generate force proportional to lid closing speed. This form is precision machined or precision die-cast, and requires three cylinders, a special damping fluid, and close manufacturing tolerances to affect damping and to prevent fluid leakage.

Another known form, mainly for use on upright cabinet doors and gates to retard opening and closing movement is disclosed in U.S. Pat. No. 5,406,678. This form employs a shaft frictionally retarded by a leaf spring. In one typical embodiment, the leaf-spring has one end fixed to a hinge leaf by screws and the other end formed into a loop around the hinge shaft. The screws both fix the end of the leaf spring and force the loop onto the shaft. These lower-cost forms fail to provide reliable retardation and they wear rapidly because although looped the spring force is applied to a narrow tangential longitudinal area of the shaft which results in rapid wear of the reciprocal surface area of the inner surface of the loop.

FIGS. 1-2 show conventional musical instrument cases. FIG. 3. shows a conventional guitar case hinge. FIG. 4 shows a typical hard guitar case. In FIG. 1, case 50 has a closure in the form of an opened hinged lid 51 and a guitar 55 in the case body 52, and with conventional upper latch elements 54a and lower latch elements 54b for selectively securing the lid in a closed position. FIG. 2 shows a typical electric guitar case 60 with a hinged lid 51 closed and latched by elements 54a and 54b. FIG. 3 shows a conventional guitar case hinge 53, as used between lid 51 and body 52 of cases 50 and 60 (although not visible) in FIGS. 1 and 2. Hinge assembly 53 provides free, substantially unrestrained rotation of a lid relative to a case. FIG. 4 shows the lid 51 of case 50 of FIG. 1 having a hinge such as hinge assembly 53, having fallen onto a guitar 55, with the upper latch element 54a biting into the guitar surface causing damage 56.

In view of the above, a compact, low cost, easy to manufacture hinge that reliably prevents a lid from inadvertently falling closed during opening and/or when the lid is upright in the open position, addressing drawbacks of the above devices and/or providing other benefits, would be advantageous. And in respect to guitar cases, no existing form can be satisfactorily and cost-effectively adapted to work well on guitar cases where the hinges must be very compact, low cost, and reliable over many years of usage, and aesthetically suitable for usage on a quality consumer product.

### SUMMARY

According to certain aspects of the disclosure, a hinge assembly may include, for example, a pair of hinge leaves attached to the ends of an assembly of a pair of longitudinal c-shaped elements formed of resilient material. The resilient material may be carbon steel, stainless steel or alloy steel, and the pair may be a first resilient c-section member of smaller diameter resiliently captured coaxially within the inner diameter of a second c-section member. It will be appreciated that various options and modifications are possible.

For example, in the relaxed state, the smaller diameter c-shaped member is slightly larger in diameter than the relaxed state of the inner diameter of the larger c-section member. Both c-shaped elements therefore resiliently contribute force to frictional torque which resists axial rotation of either member.

Each hinge leaf comprises a pair of opposed flanges at its sides at the pivotal end. A first leaf has opposed flanges spaced to fit with minimal clearance inside the flanges of a second leaf. Both pairs of flanges have holes that are axially aligned when the two leaves are in the assembly position.

The flanges of the second leaf have holes that receive the ends of the smaller diameter c-section member, and the flanges of the first leaf have holes that receive the ends of the larger diameter c-section member. Both sets of holes have a short inwardly protruding tab sized to engage the gap in each c-section member, which engagement prevents rotation of both c-section members within the holes.

The ends of the smaller diameter c-section member may protrude through the holes a little beyond the outer surface of the first hinge leaf flanges and have axle caps fixedly attached to prevent lateral movement “walkout” of the c-section member. The ends of the larger diameter c-section member terminate flush with the inner surfaces of the flanges of the first hinge leaf. Alternatively, a hinge pin with a disc-shaped head may be inserted through the center of the smaller diameter c-section member and the end of the pin riveted over to retain the pin in place.

One hinge leaf is adapted for attachment to a case body with screws or rivets, the other is adapted for attachment to the lid of the case with screws or rivets.

The c-section members are sized so that the force required to effect their coaxial rotation is more than the downward force exerted by the mass of a lid; so that the lid will stop at any point through its range of rotation when force in excess of lid weight is removed, so that the lid does not fall to potentially damage a guitar or any type of item being removed or replaced in the case, and so the lid cannot fall to harm fingers which may be on the edge of the opening of the case.

The hinge assembly preferably includes an adjustment screw to increase or reduce the frictional torque force, to allow for manufacturing tolerance and variations in lid weight.

In one optional form, one of the hinge leaves has an area of its upper outer surface recessed to accommodate a torque adjusting screw. The wall of the recessed area opposite the midpoint of the c-section members is formed inward and tapped to accept a screw. Tightening of the screw applies a force that increases the closing force of the outer c-section member around the inner c-section member, and so increases frictional torque. Additionally, tightening the screw resiliently bends the c-section pair, which inhibits coaxial rotation and so contributes to increased torque. In this way, frictional torque may be increased to support a heavier lid and to accommodate variations in frictional torque due to manufacturing tolerances of the c-section members and variations in lid mass.

In another optional form, the hinge leaves may be manufactured in pressed steel or pressure die-cast alloy, and the c-section members are produced by forming resilient carbon steel. The interface of the c-section members may be lightly coated with a molybdenum disulfide or copper-containing grease to prevent galling (adhesion and micro-tearing of the surfaces of sliding, load-bearing surfaces) to extend reliable frictional torque service life and to minimize the need for frictional torque adjustment.

In yet another optional form, the c-section members are slightly elliptical, rather than round, and are oriented such that less frictional torque is present when the case lid is raised so that less force is required to raise the lid when opening the case.

Further, for light-duty applications, the leaves and c-section pair may be formed of substantially rigid, resilient plastic material. Suitable materials include various types of injection molded plastics, nylon 6, acetal, acrylonitrile butadiene styrene (ABS).

It should be understood that the above summary is exemplary only, and is not intended to be limiting, and that the scope of the present application and is defined by the appended claims, as interpreted in view of the entire disclosure.

### BRIEF DESCRIPTION OF THE DRAWINGS

Embodiments showing aspects explaining the present disclosure are shown in the following drawings:

FIG. 1 shows a perspective view of a typical hard acoustic guitar case with its lid opened to show a guitar therein.

FIG. 2 shows a perspective view of a typical electric guitar case with its lid closed.

FIG. 3 is a perspective view of a conventional guitar case hinge, as would be used on the cases of FIGS. 1 and 2.

FIG. 4 is a perspective view of the guitar case of FIG. 1 showing the lid fallen onto the guitar causing surface damage.

FIG. 5 is a perspective view of one embodiment of a hinge assembly 10 according to the present disclosure.

FIG. 6 is a sectional view of the hinge assembly 10 of FIG. 5 taken along line 6-6 in FIG. 5.

FIG. 7 is an exploded perspective view of the hinge assembly 10 of FIG. 5.

FIG. 8 is a perspective view of another embodiment of a hinge assembly 70 according to the present disclosure having a pin 71 with head 72 and a rivetted end 73 to capture c-section 35 in flange pair 22.

FIG. 9 is a perspective view of yet another embodiment of a hinge assembly 90 according to the present disclosure having an alternative structure for retaining c-section member 35 in flange pair 22.

FIG. 10 is a section view through a slot 35a near the two ends of c-section member 35 showing the retention structure of FIG. 9.

FIG. 11 is a perspective view of a guitar case lid hinged with at least one of either of hinge assemblies 10, 70, or 90, holding a lid 51 at a stop position, preventing the lid from falling closed.

### DETAILED DESCRIPTION OF PREFERRED EMBODIMENTS

Examples showing aspects of hinge assemblies according to the present disclosure are discussed below, with reference to the drawings. Like or similar reference numerals are used across the drawings and text to identify like or similar parts in different embodiments.

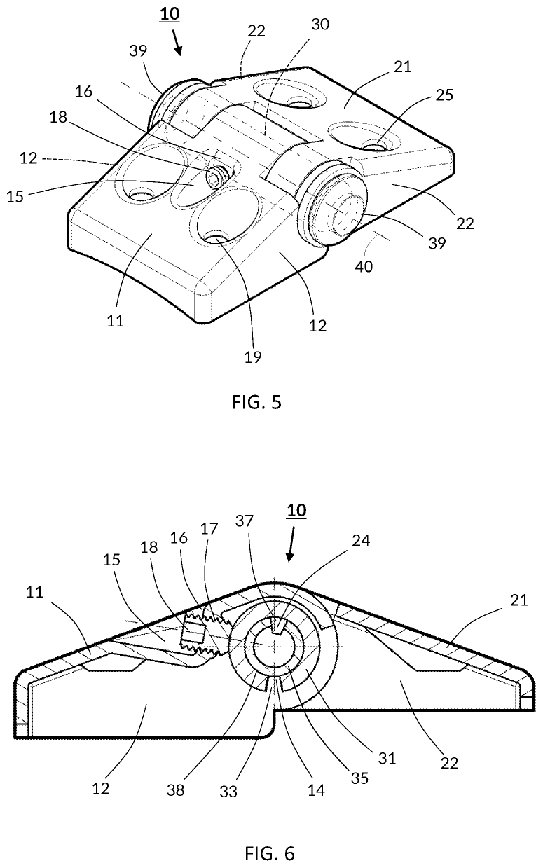

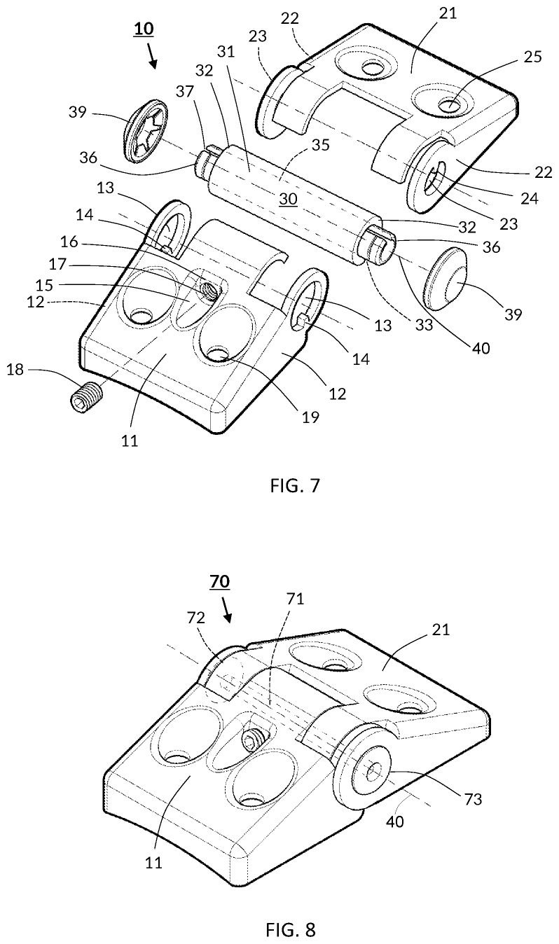

FIGS. 5-7, show one embodiment of the hinge assembly 10 according to the present disclosure, which includes a first pressed steel hinge leaf 11 and a second pressed steel hinge leaf 21; a resilient c-section pair 30 coaxially aligned along longitudinal axis 40, which may be formed of resilient carbon steel (spring steel) including an inner c-section member 35 and an outer c-section member 31. The outer diameter of the relaxed state of c-section member 35 is slightly larger than the inner diameter of the relaxed state of c-section member 31 such that when the two are assembled both c-sections resiliently contribute to frictional torque at their contact surfaces interface 38 (i.e., a radial squeeze is created at contact surfaces relative to axis 40).

When assembled to the hinge leaves 11 and 21, the ends 32 and 36 of c-section members 31 and 35 engage in respective reciprocal holes 23 and 13 in flange pairs 22 and 12 of both hinge leaves. The holes 23 and 13 in both hinge leaves have a key-tab 24 and 14 which engage with the ‘c-gap’ 33 and 37 of c-section members 31 and 35. The ends 36 of c-section member 35 protrude through holes 23 a little past the outer face of the flanges 22 and are captured by axle caps 39 to retain the c-section member 35, to prevent axial walkout. The effective diameters of both c-section members 35 and 31, wall thickness and choice of resilient steel material are selected to provide a desired rotational frictional torque force of a little more than the force generated by a case lid 51.

The hinge leaves 11 and 21 are respectively attached to a first object such as a case lid 51 and a second object such as a case body 52 (or vice versa) by screws or rivets (not shown) through holes 19 and 25. Although the present disclosure and description of hinge assemblies are depicted in use on a guitar case with a lid, it should be understood that the disclosed hinge assemblies can be used on other structures with lids or doors, such as cabinets, compartments, furniture, toyboxes, etc., and no limitation to guitar cases or instrument cases should be taken from the examples depicted herein.

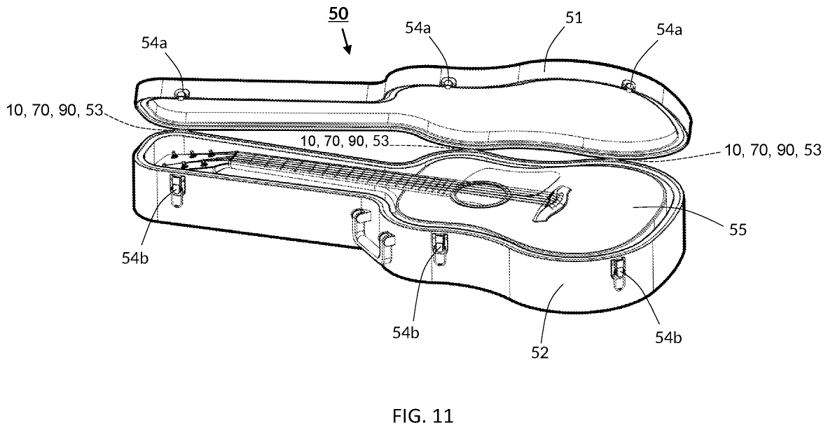

When the case body 52 is placed on a substantially horizontal surface with the case lid 51 facing upwards, and the case lid 51 (i.e., the first object) is raised from the closed position relative to the case body 52 (i.e., the second object) to open the case 50, force is transferred to resilient c-section pair 30 to cause the pair to overcome their frictional torque to rotate axially in respect to each other around axis 40 (oriented horizontally, as shown). When closing the lid 51, if force and/or torque greater than that produced by the weight of the lid is removed at any point during closing the friction torque of c-section pair 30 will be greater than the force and/or torque produced by the downward force of the case lid and its inertia, and the case lid 51 lid will quickly decelerate to a stop position, as shown in FIG. 11, and will not fall closed.

Further, as best shown in FIGS. 5-7, a recessed area 15 having a wall 16 opposite the midpoint of c-section pair 30, and having an extruded area with a tapped thread 17, provides for a screw 18 which may be tightened to increase frictional force between c-section members 31 and 35. Tightening the screw 18 inwardly has the mechanical effects of more tightly closing c-section member 31 around c-section member 35 and slightly resiliently bending the c-section pair 30 to increase frictional torque. Recessed screw 18 allows frictional torque to be increased (or decreased) as necessary to allow for cost-effective manufacturing tolerances of the c-section members and to allow for variations in case lid weight.

In another embodiment of hinge assembly 70 shown in FIG. 8, the c-section pair 30 is secured to the hinge leaves 11 and 21 by a pin 71 extending along axis 40 and having an integral disc-shaped head 72 and the end 73 expanded (rivetted) to a diameter larger than flange hole 23. The shaft diameter of pin 71 is a little smaller in diameter than the inside diameter of c-section member 35 to allow c-section member 35 to resiliently flex to a slightly smaller diameter (radially relative to axis 40) when assembled inside c-section member 31.

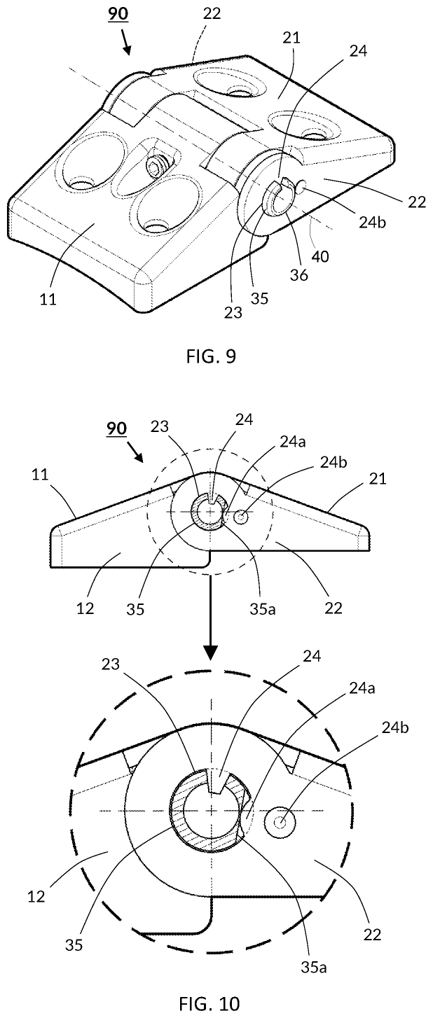

In another embodiment of a hinge assembly 90 best shown in FIGS. 9 and 10, the inner c-section member 35 is retained in the outer flange pair 22 by engagement of an expanded area 24a of the flange pair 22 at an edge of flange hole 23 within a narrow slot 35a at the ends of c-section member 35. Inward expansion of area 24a is effected post assembly of the c-section member 35 by a press tool deformation 24b which displaces material inward to enter the narrow slot 35a . Elements 24a, 24b, and 35a are radially offset from axis 40.

Although in the above embodiments the frictional pivotal movement of c-section members 31 and 35 around axis 40 is relatively slow, less than a full rotation and infrequent, likely twice per day (one lid opening and closing), and therefore friction-induced surface wear is minimal over years of usage, various types of bearing grease containing molybdenum disulfide or copper microparticles may be used on the contact faces of c-section members 31 and 35 (interface 38) to eliminate or reduce galling, fretting and scuffing, to maintain consistent frictional torque over the life of the hinge.

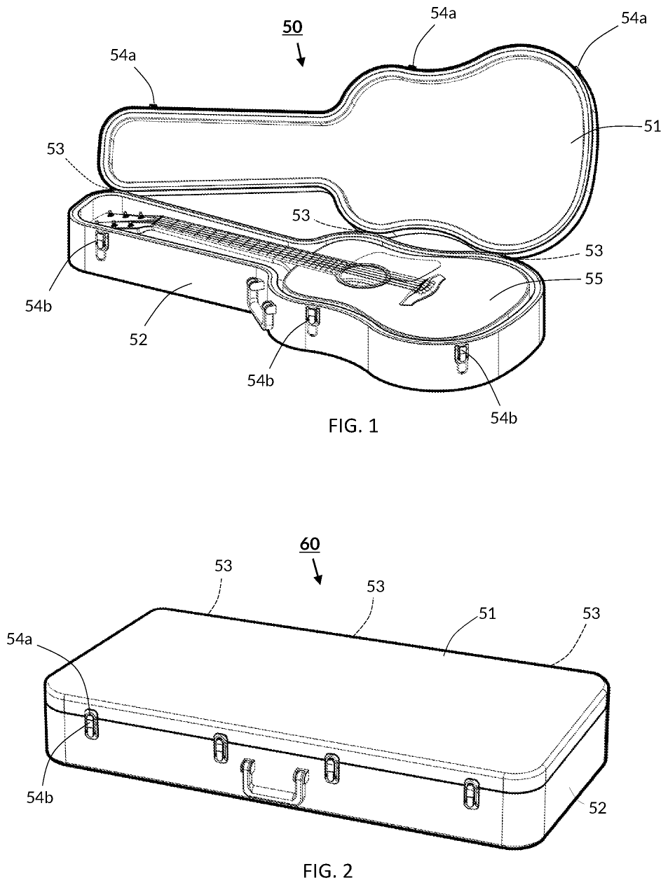

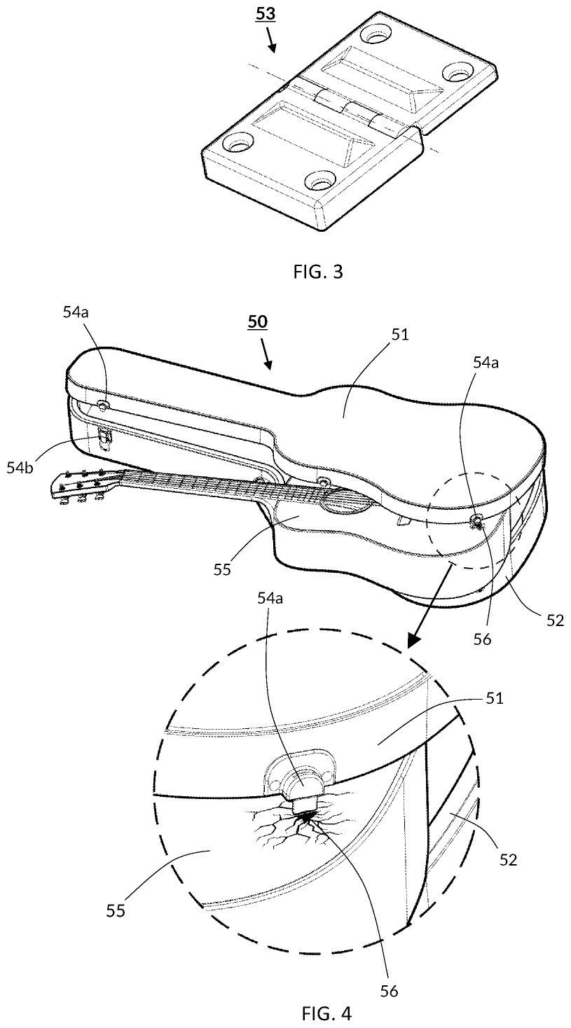

FIG. 11 shows a guitar case 50 in which at least one of the conventional hinge assemblies 53 (see FIG. 1) has been replaced with a hinge assembly according to the present disclosure, such as one of hinge assemblies 10, 70, or 90. If desired, all of the hinge assemblies 53 may be replaced in such way. However, it may be sufficient in some applications that only one hinge assembly (e.g., the middle one) may be replaced with one of hinge assemblies 10, 70, 90. Such would depend on the size and weight of the case and lid, desired adjustability of hinge friction, etc. Thus, anywhere from one of to all of the hinge assemblies of a case could be replaced with hinge assemblies 10, 70, and 90. Such would also apply to other objects, such as boxes, cases, doors, etc., having more than one hinge assembly.

Thus, aspects of the various embodiments may provide relatively simple hinge assemblies for cases, boxes, and the like which have hinged lids, specifically for helping protect against an open or a partially open lid from falling closed to strike and damage an item being removed or replaced or to strike and harm the fingers of persons accessing the contents of a case or box. Suitable applications include but are not limited to children's toy boxes, scientific instruments, and musical instruments. A particularly suitable application is hard-cases for acoustic and electric guitars which have smooth highly polished surfaces which are easily damaged by a falling lid bringing projecting latch hardware into forceful contact with the surfaces. Whereas a falling lid may inflict a cherished or expensive guitar with damage guitarists commonly call “case-bite,” use of the disclosed subject matter may provide a benefit of reducing or eliminating such incidences. The disclosed subject matter also has applicability to reducing or preventing unwanted closure of other lids or doors beyond instrument cases, where damage or injury might occur due to such closure, whether the axis of movement is horizontal as depicted in the figures herein, or otherwise oriented in a vertical or other fashion.

Thus, it will be appreciated that other embodiments of disclosed hinge assemblies, of various sizes, may be easily produced to prevent the inadvertent falling closed of lids of various weights used for cases of different sizes for many different storage applications. Furthermore, various materials such as metals and plastics may also be used in the manufacture of variations of the above-presented embodiments.

1. A hinge assembly for pivotably mounting together a lid and a container body, the hinge assembly comprising:
a pair of hinge leaves, a first hinge leaf being adapted for attachment to a lid and a second hinge leaf being adapted for attachment to a container body, each of the first hinge leaf and the second hinge leaf having a respective pair of opposed flanges, a first pair of the opposed flanges being sized to fit between a second pair of the opposed flanges; and
a friction torque pair extending along a longitudinal axis and including a first c-section member configured to be resiliently biased toward a smaller diameter which axially captures in its inner diameter a second c-section member configured to be resiliently biased toward a larger diameter, both the first c-section member and the second c-section member being adapted to connect the first hinge leaf and the second hinge leaf, the first c-section member and the second c-section member being configured of substantially rigid resilient material so as to provide friction torque such that when the longitudinal axis is horizontally oriented with the second object below the first object that movement of the lid in a closing direction toward the container body requires greater force than created by a weight of a lid to cause axial rotation of the c-section members in respect to each other.

2. The hinge assembly of claim 1, wherein the first c-section member and the second c-section member are formed of resilient steel.

3. The hinge assembly of claim 1,
wherein both pairs of opposed flanges define holes that axially align in assembly along the longitudinal axis, and wherein the holes of the first pair of opposed flanges receive ends of the first c-section member for non-rotational engagement, and the holes of the second pair of opposed flanges receive ends of the second c-section member for non-rotational engagement.

4. The hinge assembly of claim 3, wherein the holes of both the first pair of opposed flanges and the second pair of opposed flanges have a tab inwardly protruding on an inner face of at least one of the holes of each of the pairs of opposing flanges, the tab being configured to engage with a c-gap in a respective one of the first c-section member and the second c-section member to prevent relative rotation of the respective one of the first c-section member and the second c-section member.

5. The hinge assembly of claim 1
wherein one of the hinge leaves defines a recessed area configured for receiving a screw, wherein tightening of the screw closes the first c-section member more tightly around the second c-section member to thereby increase applied force and thereby increase friction torque between the first c-section member and the second c-section member.

6. The hinge assembly of claim 5, wherein the screw when tightened causes axial bending of the friction torque pair to thereby increase friction torque.

7. The hinge assembly of claim 1,
wherein each of the first hinge leaf and the second hinge leaf defines at least one hole configured to receive one of a screw or a rivet for attachment respectively to the first object and the second object.

8. The hinge assembly of claim 1, further including axle caps retaining the first c-section member in the hinge assembly.

9. The hinge assembly of claim 1,
wherein the first c-section member defines a shallow trench near at least one end configured to accept an expanded area of an edge of at least one end receiving hole of the second pair of hinge leaf opposed flanges to retain first c-section without need of the axle cap.

10. The hinge assembly of claim 1,
wherein contacting surfaces of the first c-section member and the second c-section member are lightly coated with a molybdenum disulfide, copper-containing grease or suitable grease to provide long-lasting protection against galling.

11. The hinge assembly of claim 10, wherein the lid and container body comprise a musical instrument case.

12. A case for holding a musical instrument, the case including a hinge assembly according to claim 1, wherein the first object is a lid of the case and the second object is a body of the case.

13. The case of claim 12, further including at least one of a latch element for releasably securing the lid to the body when the lid and the body are in a closed configuration, each latch element including a first latch element on the lid and a second latch element on the body, and a carry handle.

14. A case for holding a musical instrument, the case comprising:
a case body defining an opening and an interior configured to receive the musical instrument;
a lid configured for selectively closing the opening to the container body to secure the musical instrument in the interior;
a hinge assembly including a pair of hinge leaves, a first hinge leaf being attached to the lid and a second hinge leaf being attached to the case body, each of the first hinge leaf and the second hinge leaf having a respective pair of opposed flanges, a first pair of the opposed flanges being sized to fit between a second pair of the opposed flanges; and
a friction torque pair extending along a longitudinal axis and including a first c-section member configured to be resiliently biased toward a smaller diameter which axially captures in its inner diameter a second c-section member configured to be resiliently biased toward a larger diameter, both the first c-section member and the second c-section member being adapted to connect the first hinge leaf and the second hinge leaf, the first c-section member and the second c-section member being configured of substantially rigid resilient material so as to provide friction torque such that when the longitudinal axis is horizontally oriented with the case body below the lid that movement of the lid in a closing direction toward the case body requires greater force than created by a weight of the lid to cause axial rotation of the c-section members in respect to each other.
